(19) United States
(12) Patent Application Publication
(10) Pub. No.: US 2002/0078241 A1
(43) Pub. Date: Jun. 20, 2002

(54) Method of accelerating media transfer

(75) Inventors: Victor Vidal, New York, NY (US); Dotan Shidlovsky, New York, NY (US); Oren Segal, New York, NY (US)

Correspondence Address: DARBY & DARBY P.C., 805 Third Avenue, New York, NY, 10022, US

(73) Assignee: ALFY, Inc.

(21) Appl. No.: 09/738,594

(22) Filed: Dec. 15, 2000

(51) Int. Cl. G06F 15/16

(52) U.S. Cl. 709/247; 709/231

(57) ABSTRACT

A method for transferring an at least partly compressible file from a server computer to a user computer, the server computer and user computer being connected via a communication network, the method including the steps of at least partly compressing the at least partly compressible file to produce a corresponding compressed file, storing the compressed file on the server computer, upon request, transferring the compressed file to the user computer, and decompressing the compressed file at the user computer to reconstruct the at least partly compressible file.

### BACKGROUND OF THE INVENTION

Downloading files from a computer network, for example, a global computer network, can be extremely time consuming. This problem is particularly apparent when downloading audio and/or visual files and programs when the user is interested in listening to and/or viewing the downloaded information on an immediate basis. To minimize this problem, efforts are constantly being made towards developing compression and decompression algorithms that allow transfer of a relatively small amount of information via bottleneck communication links, such as a modem network connection. Even with faster and more advanced communication technologies, such as cable and DSL modems, compression is still an important tool in minimizing download time and making the download process more efficient.

The term “streaming” is well known in the art and refers to continuous flow of data to a user's computer from a server via a network connection, wherein streamed information is continuously presented to the user as it is received. The speed at which the data moves is limited by the network connection. The typical connection for most current users is a modem running at 56 Kilo bits per second (Kbps) or slower; however, there are much faster alternatives, such as cable modems and Digital Subscriber Line (DSL) modems, that are becoming more and more widespread.

As known in the art, the data of a Macromedia Flash™ movie file is stored sequentially, e.g., in accordance with the sequence of the movie frames. According to this scheme, as soon as the Flash Player™ receives all of the data for a given frame of a Flash™ movie, the Player software may immediately proceed to render that frame on the user's screen without having to wait for additional data that relates to later frames.

Image data and sound data are stored somewhat differently in Flash™ format files. Image data in Flash™ files consists of a set of coordinate values corresponding to each “curve” and “fill” to be included in the displayed image. Any graphic which is not converted into a symbol, a bitmap, or text, is stored in each and every frame of the Flash™ file in which the graphic appears. In contrast, the complete image data for a graphic to be converted into a symbol is stored only in the first key frame in which the symbol appears. Subsequent frames using the same symbol do not include the image data for that symbol. Rather, each subsequent frame merely references the symbol's data from the key frame in which it first appears and stores only information about changes in position, rotation, scale or color that are applied to the symbol in the new frame. Bitmaps and text data are similarly stored in the first frame in which they appear. It is appreciated, however, that animated symbols are an exception to this rule, because all the data of an animation is stored in each frame in which the animation appears.

Sound data in Flash™ files may be stored in one of two ways. Event sounds, such as button clicks, are stored in much the same way image symbols are stored i.e., the data of each event is stored in the first key frame in which the event appears. Once an event appears in a key frame, the event may be simply referenced by later key frames, storing only changes in the data of the sound event relative to the first key frame. For streaming sounds that are not categorized as events, the Flash™ file divides the data into small chunks, which are stored in a group of frames over which the sound is to be played back. These sound chunks are subsequently reconstructed into a single audio stream during playback of the Flash™ movie.

In order to play a Flash™ movie smoothly, the Flash Player™ software must receive data over the network connection at least at the rate, measured in frames per second, at which the movie is to be played back. Generally, to ensure that a Flash Player™ movie plays smoothly from start to finish, the amount of data representing each frame should preferably be small and the data representing the frames should preferably be downloaded at least at the intended playback rate. Also, it is appreciated that the playback rates may vary from computer to computer because Flash™ movie playback rate may vary with processor speed, video memory and/or other factors. To playback a given frame, Flash™ technology requires that all elements of the frame, such as event sounds, bitmaps, and vector shapes, be downloaded in their entirety. When the movie being played back reaches a point at which a frame cannot be rendered in sequence because it requires longer downloading time, playback of the movie is stopped until downloading of the delayed data is completed. Similarly, when a Flash™ movie has complex items or a large number of items in the first frame, it may take a long time to download all those items before the first frame may be displayed. If subsequent frames are also large and/or complex, a Flash™ movie may play in spurts, i.e., it may periodically slow down to await new data and may periodically speed up when the data is streamed at a faster rate.

For optimal playback performance with large and/or complex movies, it is common practice to download a specified series of frames, or even the entire movie, before playback begins. This method, known as preloading, prevents playback of the movie until all the specified frames have been downloaded.

Macromedia Flash™ technology is widely used for providing rich, vivid, interactive, engaging and dynamic content on a computer network, e.g., on the World Wide Web. Flash™ files are commonly downloaded from the Internet using the streaming technology described above, wherein segments of the file are sequentially downloaded onto a user's computer, and are subsequently reconstructed at the user's computer. Unfortunately, Flash™ files are typically much larger than the files commonly used for generating non-Flash™ content, e.g., HTML files, Java Script, ASP, JSP, GIF and JPEG and, thus, the technology is limited in the amount of information that may be transferred and presented (e.g., played back) in real time to the user.

It is appreciated that the limitation on the ability of existing systems to efficiently transfer Flash™ and similar files over communication networks results in a significant limitation on the application of Flash™ and similar technologies, especially over the Internet.

### SUMMARY OF THE INVENTION

The inventors have discovered that the process of downloading and executing files in various formats that have become standards on the World Wide Web, for example, Macromedia Flash™, Macromedia Shockwave™ and Java Applet™, may be accelerated to an extent that may significantly improve the efficiency of using these formats and technologies.

In accordance with the invention, when a streamed media file, such as a Macromedia Flash™ file, becomes available for distribution via web servers, it is compressed by a component of the present invention, as described below, and the compressed file is uploaded onto web servers, instead of the original media file. Thus, the compressed file is ready to be downloaded or streamed upon request from the user.

Part of the system of the present invention may be implemented in the form of a software component installed on a user's personal computer. This component may include a media decompress program, as described below. The user part of the system is preferably associated with the web browser and the Internet connection of the user's computer. Once a request for a media file, such as Macromedia Flash™ is detected, the request is automatically converted into a request for the compressed version of the same file. When the compressed file is received from the web server, the decompress program on the user's computer decompresses the file to reconstruct the original media file on the user's web browser. Thus, as described below, the modification of the download process is performed “behind the scenes” and is transparent to the user, whereby the user is not required to deviate from standard downloading procedures.

In some preferred embodiments, the user part of the system may be implemented in the form of a software component installed on an intermediary server, such as an Internet Service Provider (ISP) caching server, a proxy server, or a server dedicated specifically for that purpose. In other preferred embodiments, at least part of the user side of the system may be implemented in the form of a hardware component, such as a computer microchip.

In some embodiments of the invention, the user component may include a special media format (or file format) as follows. The compressed file may be saved in a format which includes information beyond the actual compressed content. This additional information may be stored in order to properly support the decompression component. For example, the size in bytes of the original file, e.g., a Macromedia Flash™ file, may be stored and subsequently used by the decompression program, because this information may be required by the software that plays back the media, e.g. for the Flash Player™ in the above example.

Using the method of the invention, Macromedia Flash™ or similar media data files may be streamed to a user's computer via a communication link in a significantly compressed format, enabling streaming about 10%-45% less data, and typically about 25% less data, through the communication link. Thus, the method of the invention significantly expedites, i.e., accelerates, media streaming, reduces bandwidth usage and reduces preloading time.

The present invention provides a novel compression and decompression method, designed specifically for accelerated transfer of streamed-media files, for example, Macromedia Flash™ files, Macromedia Shockwave™ files, Java Applet™ files, and any other file format used for streaming data.

In accordance with an embodiment of the present invention, there is provided a method for downloading a file, for example, a streamed-media file, from a web-server onto a user's computer, the method including the steps of:

(a) compressing the streamed-media file to produce a compressed-media file;

(b) uploading the compressed-media file to the web server;

(c) upon request, transferring the compressed-media file to the user's computer; and

(d) decompressing the compressed media file at the user's computer to reconstruct the streamed-media file.

The above described steps (a) and (b) may be performed in advance, e.g., in preparation for subsequent download requests. Therefore, steps (a) and (b) alone may define a method of preparing files for an accelerated download, and steps (c) and (d) alone may define a method of downloading files which have been modified for accelerated transfer according to the invention. Alternatively, the above steps (a) and (b) may be performed “online” or “in real time”, i.e., in response to a specific file request.

Preferably, the method further includes the step of presenting information carried by the streamed-media file to the user after decompression of the downloaded file has been completed.

### BRIEF DESCRIPTION OF THE DRAWINGS

The present invention will be understood and appreciated more fully from the following detailed description of preferred embodiments of the invention, taken in conjunction with the following drawings in which:

FIG. 1 is a schematic, block diagram, illustration of a web server side of a system for accelerating media transfer in accordance with an embodiment of the invention;

FIG. 2 is a schematic, block diagram, illustration of a user side of a system for accelerating media transfer in accordance with an embodiment of the invention;

FIG. 3 is a schematic, block diagram, illustration of pre-download part of a method for accelerating transfer of media files in accordance with an embodiment of the invention;

FIG. 4 is a schematic, block diagram, illustration of post-download part of a method for accelerating transfer of media files in accordance with an embodiment of the invention;

FIG. 5 is a schematic, block diagram, illustration of a compression algorithm for use in conjunction with a method of accelerating media transfer in accordance with an embodiment of the present invention; and

FIG. 6 is a schematic, block diagram, illustration of a decompression algorithm for use in conjunction with a method of accelerating media transfer in accordance with an embodiment of the present invention.

### DETAILED DESCRIPTION OF PREFERRED EMBODIMENTS

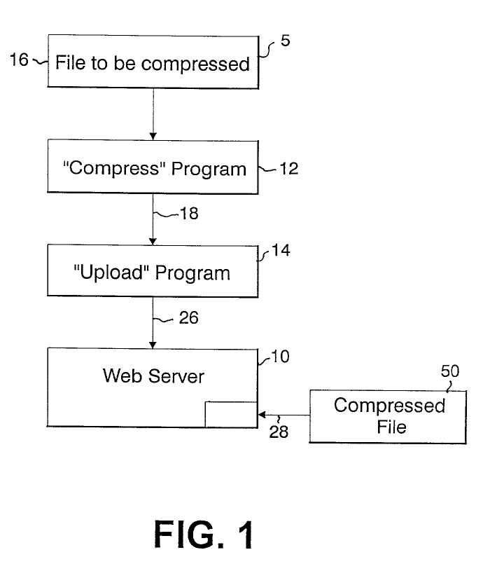

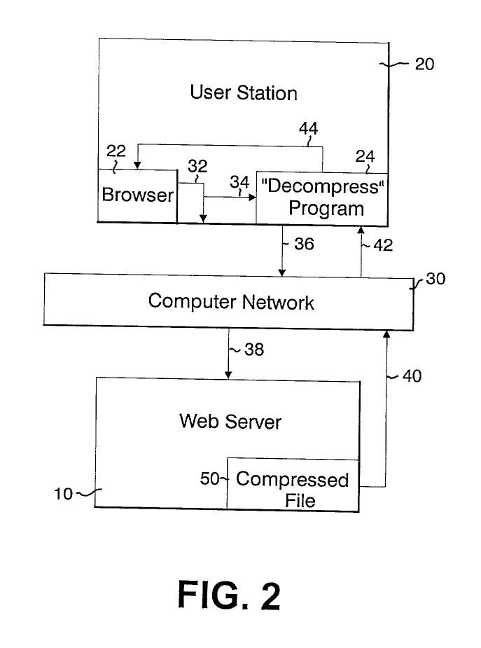

Reference is made to FIGS. 1 and 2 which schematically illustrate a system for accelerating transfer of media files in accordance with the invention. FIG. 1 shows a compression and upload part of a preferred system. FIG. 2 illustrates a download and decompression part of the preferred system.

As shown in FIG. 1, the system includes a web-server 10, which may include any system capable of communicating with users of a communication network (e.g., the Internet) to provide services, as is known in the art. The system further includes a media compress program 12 and a file upload program 14, both of which may be implemented in the form of computer software or hardware associated with web server 10.

As explained below, the media compress program may used as an “off-line” compression program, for example, in preparation for subsequent downloads. In other words, the compression may be performed in advance, on a personal computer or a computer server, typically not on web-server 10. Alternatively, media compress program 12 may be activated “on-line” upon a user requesting a particular file, as described below.

Referring to FIG. 2, the system further includes a user station, for example, a personal computer as is known in the art, which communicates with a computer network 30, for example, a global computer network such as the Internet, via a communication link (not shown), such as a communication modem connection. User station 20 includes a web browser program, as is known in the art, and a media decompress program 24 in accordance with the present invention. Media decompress program 24 may be implemented in the form of computer software on user station 20. Web server 10 also communicates with computer network 30 via an appropriate communication link, as is known in the art, enabling two-way communication between user station 20 and web server 10.

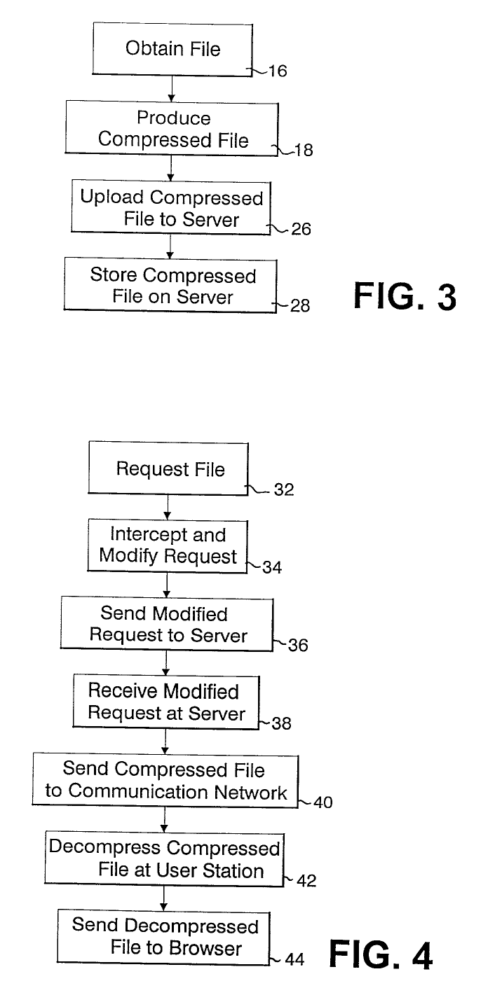

Reference is made to FIG. 3 which schematically illustrates a pre-download sequence in a method of accelerating downloads in accordance with the present invention. According to the method of the invention, as indicated at block 16, a media file in a given format, for example, a Macromedia Flash™ movie file 5, is received by the compress program 12 which compresses the media file to produce a compressed media file 50, as indicated at block 18. The compressed media file 50 is then uploaded from compress program 12 onto web server 10, as indicated at block 26, and stored on web server 10, as indicated at block 28. At this point the file is ready for download, as described below. The pre-download part of the method illustrated in FIG. 3 may be performed “off-line”, i.e., in advance, whereby files are ready for subsequent downloads from server 10, as described below. Alternatively, the media files to be compressed for downloading may be obtained, compressed and stored “on line”, or in “real time”, i.e., upon receipt of a particular request from the user.

Reference is now made to FIG. 4 which schematically illustrates a post-download part of a method of accelerating the downloading of media files in accordance with the invention. At the user station side, browser 22 sends a request to download media file 5, as indicated at block 32. This request is preferably intercepted by media decompress program 24 of user station 20, which replaces the original request with a request to download compressed media file 50 instead, as indicated at block 34. However, in some embodiments of the invention, browser 22 may request the compressed file directly, i.e., the file request may be modified by software in user station 20, for example, by a “plug-in” or feature added to web browser 22, rather than being intercepted and modified by decompress program 24.

Decompress program 24 sends the modified request to computer network 30, as indicated at block 36, and the modified request is received by web server 10, as indicated at block 38. In response to the modified request, web server 10 sends compressed media file 50 to computer network 30, as indicated at block 40, and the compressed file 50 is received by decompress program 24, which decompresses the file to reconstruct the original media file 5, as indicated at block 42. To complete the process, decompress program 24 sends the reconstructed media file 5 to web browser 22, as indicated at block 44.

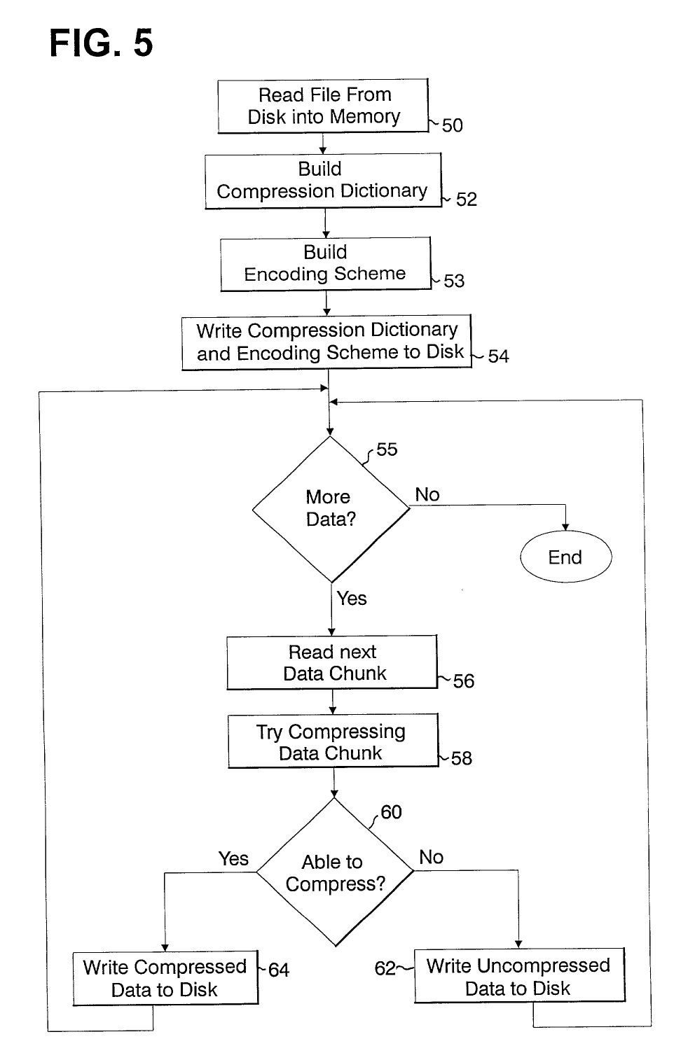

Reference is now made to FIG. 5 which schematically illustrates key steps performed by compress program 12. A file to be compressed is retrieved from a memory, such as a hard drive, as indicated at block 50. The compress program may then build a compression dictionary (described below), as indicated at block 52, and apply an appropriate encoding scheme, as indicated at block 53. For example, a Huffman tree type encoding scheme may be used to encode files in Macromedia Flash™ format, as described below.

Building the compression dictionary includes searching for sequences of symbols (e.g., characters) that repeat themselves throughout the data, as is known in the art. Once the repeated sequences are located, they are organized in a table which is stored in memory. Each sequence in the stored table may be assigned a unique code. In the process of encoding (i.e., compressing) the data, the sequence codes may be used instead of the actual sequences. This reduces the amount of data being stored and subsequently transferred, because the assigned codes are generally shorter than the sequences they represent. On the decoding (i.e., decompression) side, the codes are read and the dictionary table described above may be used to recreate the original sequences. Algorithms suitable for such encoding and decoding processes are well known in the art. The dictionary table itself may be transferred together with the compressed data, as part of a general compression header as is known in the art.

The above described process results in a sequence of chunks of data which together correspond to the original file. The data chunks are then preferably processed sequentially, i.e. one chunk at a time, and the program tries to compress each data chunk, as indicated at block 58. The program then determines whether the data chunk is compressible, as indicated at block 60. If the data chunk is incompressible (in accordance with criteria described below), the uncompressed chunk is written onto a memory or buffer of a server, such as web server 10, or an offline computer disk, depending on whether the compression is performed online or offline, as indicated at block 62. If the data chunk at block 60 is determined to be compressible by the algorithm of the present invention, the compress program compresses the data and writes a corresponding compressed data chunk onto the memory or buffer being used, as indicated at block 64. This completes the download preparation process, that may be preformed in advance, e.g., off line, or in response to an actual request from a user, i.e., on line, as described herein.

In a preferred embodiment of the invention, the compression algorithm may operate as follows. First, the algorithm may search for symbols (characters) that appear more frequently than others in the data. Then, the algorithm may build a tree, for example a Huffman Tree, as is known in the art, that stores the symbols and their respective frequencies. Each symbol may then be assigned with a code whose length is inversely proportional to the frequency of the symbol. For example if the symbol ‘A’ appears significantly more frequently than the symbol ‘B’, then the code length of ‘A’ should be shorter than that of ‘B’. During the encoding process, the algorithm may write the symbol code into memory, instead of the data corresponding to the symbol. This code includes information sufficient to reconstruct the symbol and its frequency. Thus, during decoding, the code may be read and the Huffman tree may be used to reconstruct the original data, as is known in the art. The tree itself may be transferred together with the compressed data, as part of the general compression header as is known in the art.

In order to determine whether a file is compressible, and if so, which compression algorithm should optimally be used, the compress program may perform the following. First, the compress program may read a block of data having a predetermined size, for example, a block size of about 7 Kilobytes has been found suitable for 56 Kbps modem communication links. Then, the compress programs tries to compress the block using various algorithms, for example, either or both of the above described dictionary and Huffman encoding algorithms. The compress program may also try various combinations of the algorithms described above and/or other algorithms. Based on these trials, the compress program selects the algorithm or combination of algorithms which yields the highest compression ratio. At this point, the compress program may determine whether the compression ratio is sufficiently high to warrant compression of the entire file, as indicated at block 60, by determining if the compression ratio exceeds a preset threshold. The threshold may correspond to a reduction of a predetermined percentage of the amount of data in the chunk due to compression, for example, a 5% reduction, or any other threshold that yields optimal results based on experimentation with a specific file format. If the compression ratio is determined to be sufficiently high, the compress program proceeds to write the compressed data block onto the disk. However, if the compression ratio is not sufficient, i.e., the size of the original file may not be significantly reduced, then the compress program may write the original data block to disk.

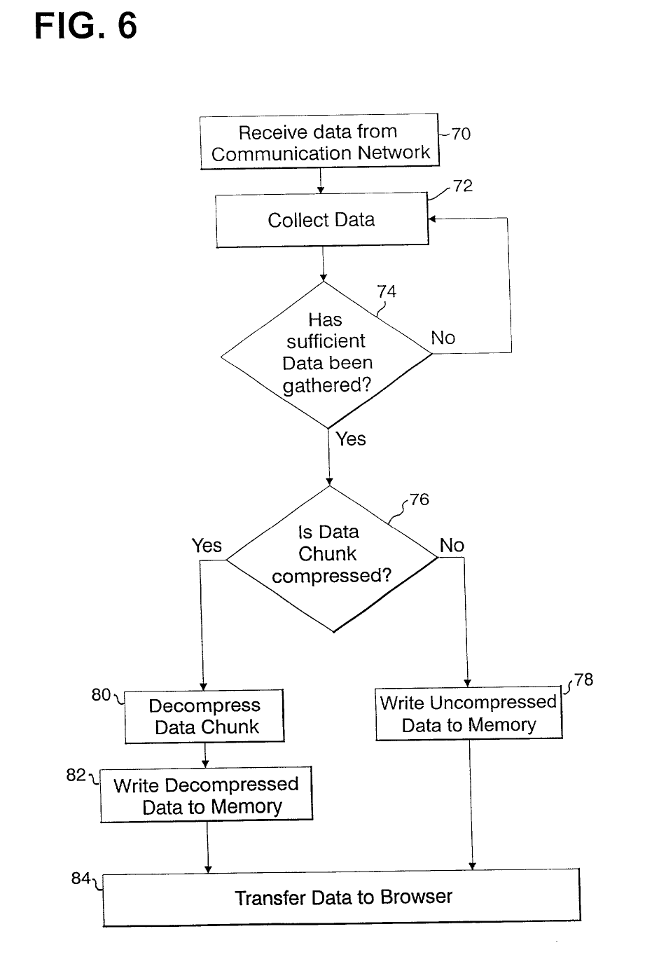

Reference is now made to FIG. 6 which schematically illustrates key steps performed by decompress program 24. Data is received from computer network 30, as indicated at block 70. The received data is then collected in temporary memory storage, as indicated at block 72, and the decompress program determines whether sufficient data has been collected, as indicated at block 74. A preferred criterion for this determination is whether a predetermined size of data chunk has been accumulated, for example 7 Kilobytes may be a suitable chunk size for a 56 Kbps modem. If the criterion at block 74 is not met, the program waits for additional data to be collected. Once sufficient data has been collected, the program proceeds to determine whether the data chunk is compressed beyond its original format, as indicated at block 76. If the data chunk is not compressed, the program writes the data onto a memory or buffer of user station 20, as indicated at block 78. Finally, the data chunk is transferred to the browser program 22, which may cause the data to be presented, e.g., displayed to the user on a display (not shown) associated with user station 20. If the data chunk at block 76 is compressed, the decompress program decompresses the data chunk, as indicated at block 80, and writes a corresponding decompressed data chunk onto the memory or buffer of user station 20. The data may then be transferred to browser 22, as indicated at block 84, which may cause the data to be presented, e.g., displayed to the user on a display (not shown) associated with user station 20. The process described in FIG. 6 ensures that only data that had been compressed prior to its transfer is subsequently decompressed by decompress program 24.

A compressed file in accordance with the present invention contains a file header (commonly referred to as “general compression header”), which contains the dictionary table and/or the Huffman Tree table, as described above, or other data reconstruction tools that may be used by other types of compression algorithms, to be used for subsequent decompression of all the data chunks in the file. Preferably, all compressed data chunks may be reconstructed from the same dictionary and/or Huffman Tree and/or other reconstruction tools included in the general header. However, as described below, a given data chunk may require the use of only one reconstruction tool (e.g., a Huffman tree), or more than one reconstruction tool, or any other combination of reconstruction tools, or no reconstruction tools, depending on the type of compression selected for that particular data chunk during compression, as described above.

Each data chunk may contain a chunk-specific header, which may include information regarding the compression type, i.e., which algorithm (if any) had been used to compress the data chunk before the transfer, and the size of the chunk (block size), e.g., in Kilobytes. In each data chunk, the header may be followed by actual data. Data is collected in a temporary memory buffer, as described above. If the data block is uncompressed, the data is transferred with no further processing to the browser. If the data block is compressed, the decompress program may wait (if necessary) until a sufficient amount of compressed data arrives, typically at least one data chunk, before decompressing the data chunk and transferring it to the browser, as described above with reference to FIG. 6.

It should be noted that data is received from the computer network in “bursts” of varying sizes that typically range from a few bytes to several Kilobytes, depending on the communication medium. Therefore, the decompress program must collect complete chunks of data, in accordance with the compression scheme described above, before the program may proceed to process the data. It should be appreciated, however, that the file formats and compression schemes may vary from those specifically described above, e.g., various combinations of the dictionary table and/or Huffman Tree with other compression algorithms may be used to accommodate various file formats.

It should be noted that decompress program 24 is preferably adapted to decompress the data received and provide it to the web browser on the fly, i.e., during streaming. In practice, the decompression component receives a first packet or chunk of compressed data, decompresses it, and sends it to the web browser which can begin displaying the data, as described above. The program may then continue processing the next packet or chunk of data. As the data continues to flow in chunks, each chunk of data is individually decompressed (if necessary) and delivered to the web browser.

It should be appreciated by persons skilled in the art that the process described above enables much faster downloading and streaming of media files, compared to prior art methods which transfer the media files in a non-compressed form. Further, it should be appreciated that downloading or streaming media files in accordance with the present invention is transparent to the user, i.e., the user perceives what seems to be a conventional downloading or streaming process, except for the fact that the downloads in accordance with the present invention are generally much faster than conventional downloads.

It has been discovered that the compression rate in accordance with the present invention may be between 10% and 45%, typically 25%, depending on the format of media file 5 and the internal structure of the particular file being streamed or downloaded.

Although the system and method of the present invention are particularly suitable for downloading and streaming Macromedia Flash™ files, it should be appreciated that the invention may also be adapted to other file formats, for example, Macromedia Shockwave™ and Java Applet™, as well as any other file formats that may benefit from pre-transfer compression in accordance with the invention. Further, the media transfer method of the invention may be implemented in conjunction with any operating system and browser platform known in the art, for example, Microsoft Windows™ platforms, and Internet Explorer™ and Netscape Navigator™ browsers.

Although the present invention is particularly useful in accelerating the transfer of streamed-media files, such as Macromedia Flash™, Macromedia Shockwave™ and Java Applet™ files, it should be appreciated that the invention may also be useful in accelerating the transfer of other file types, for example, HTML, JavaScript™, GIF, JPEG files and Microsoft Word™, Microsoft Excel™ and Adobe Acrobat™ documents, as well as any other file formats known in the art. The invention is particularly suitable for streamed-media files because some of the other file types mentioned above (e.g., HTML) are typically not large enough to warrant compression, and others of the file types mentioned above (e.g., GIF and JPEG) are sufficiently compressed and may not benefit significantly from further compression. Additional file types, such as Microsoft Word™, Microsoft Excel™ and Adobe Acrobat™ documents, may be large enough to warrant compression in accordance with the invention, but are typically not used for transferring large amounts of information over communication networks. The invention has been described above in conjunction with Macromedia Flash™, Macromedia Shockwave™ and Java Applet™, because these formats are generally not fully compressed, i.e., they are provided in a format that may be further compressed, and are routinely streamed over communication networks. This further compression is provided by the present invention, prior to transfer of such files over a communication link.

It should be appreciated that the invention may be implemented in conjunction with any type of communication network known in the art, including but not limited to internal networks, Intranets, Extranets, as well as global computer networks, such as the Internet. However, the invention is particularly helpful in cases of slow network connections, such telephone modem connections.

In order to optimize downloading time, from the user's perspective, the method of the present invention may include a step of selecting an appropriate compression algorithm, followed by a step of further optimizing the selected algorithm. The compression scheme of the invention may be tailored to accommodate specific data types and communication media, and customized content encoding and dictionary tables may be used for specific data types. Data chunk size may be optimized to a given communication medium and communication bandwidth, e.g., standard phone line, DSL modems, cable modems, local network, etc. For example, a data chunk of about 7 Kilobytes has been found to be optimal for use with a 56 Kbps standard phone line modem connection.

Further, the data may be compressed differently for different file formats. For example, the Macromedia Flash™ file format (swf) contains special codes for various types of information (commonly referred to as “TagID's”), and repeated information (e.g., headers/footers) may be predicted and is thus compressible. For those codes, a customized Huffman coding tree may be generated, including specialized shorthand codes for the data, wherein higher data frequencies may be represented by shorter codes, as described above.

In a preferred embodiment of the invention, the dictionary table described above may be optimized by relying on pattern reoccurrence. As described above, recurring information may be stored in the dictionary table, which is a form of a hash table. When recurring information is found it may be written in compressed form, i.e., as a special shorthand code instead of the original longer data. According to the present invention, the dictionary size and organization may thus be optimized for the communication medium and the data type. For example, an optimal dictionary size for a 56 Kbps modem connection has been found to be about one Kilobyte. The optimal dictionary organization scheme may be constructed by scanning the Macromedia Flash™ file for repeating string patterns and populating the dictionary with those patterns.

In accordance with an embodiment of the invention, the block size, dictionary size and dictionary organization may be optimized to be specifically suited for the Macromedia Flash™ file format and a 56 Kbps modem bandwidth. Using various modifications, which will be apparent to a person skilled in the art, the compress program of the present invention may be adjusted to any other file format and communication media known in the art.

In accordance with some embodiments of the invention, Macromedia Flash™ or similar format files are stored on web server 10 in their original, non-compressed format. Compress program 12 is then run on the web server for each request received from the user's web browser 22 for a particular media file. The request may indicate that decompression program 24 is installed and running on user station 20, e.g., on the user's personal computer. Compress program 12 may then automatically compress the Macromedia Flash™ or similar file, store the compressed file on a buffer memory of the web server, and send the compressed file to the user. This obviates the need to prepare the compressed files in advance, which may save developer's time and enables an efficient streamlined process. Additionally, such an automated process may be used in processing requests for files not previously stored on the web server, wherein the files may be retrieved online from other locations on the communication network, e.g., from world wide web sites containing compressible copies of the requested files. Such an automated compress option program may be written in various formats, for example, as an ISAPI DLL, as a Windows Service, or as a Unix daemon, or any other suitable format known in the art.

In some embodiments of the invention, the compression program is optimized for different communication speeds, such that different compressed versions of the same file may be created and uploaded onto the web server. For example, a Macromedia Flash™ file optimized for a 56 Kbps speed modem may be prepared and uploaded onto the server with the label “File_{—}56K.ALF.SWF”; whereas a file optimized for a 384 Kbps DSL modem may be prepared and uploaded onto the server with the label “File _{—}384K.ALF.SWF”. In accordance with this embodiment, a user installing decompression program 24 on a personal computer may customize the decompression program to the speed of the network connection being used. Thus, decompression program 24 may automatically configure itself to retrieve, upon request, the appropriate compressed file format. Alternatively, in some preferred embodiments of the invention, decompression program 24 may automatically detect, in real time, the effective speed over the communication line, and request the appropriate compressed file format which corresponds (or most closely corresponds) to the communication speed.

In some embodiments of the invention, decompression program 24 resides on the user's web browser, i.e., as an “add-on”, or “plug-in”, for example, an ActiveX™ control or Netscape™ plugin. Alternatively, decompression program 24 may be designed as an integral part of web browser 22. For example, in analogy to the built-in ability of Microsoft Internet Explorer™ to display GIF files or to play MIDI files, the above described features of decompress program 24 may be implemented as a built-in feature of web browser 22.

It will be appreciated by persons skilled in the art that the present invention is not limited to the specific embodiments described above with reference to the accompanying drawings. Rather, the present invention is limited only by the following claims:

1. A method for transferring an at least partly compressible file from a server computer to a user computer, the server computer and user computer being connected via a communication network, the method comprising the steps of:
at least partly compressing the at least partly compressible file to produce a corresponding compressed file;
storing the compressed file on the server computer;
upon request, transferring the compressed file to the user computer; and
decompressing the compressed file at the user computer to reconstruct the at least partly compressible file.

2. A method according to claim 1 and further comprising, after the step of decompressing, the step of converting the reconstructed file into a form presentable to the user.

3. A method according to claim 1 wherein the at least partly compressible file comprises a streamed-media file.

4. A method according to claim 3 wherein the streamed-media file comprises a Macromedia Flash™ file.

5. A method according to claim 3 wherein the streamed-media file comprises a Macromedia Shockwave™ file.

6. A method according to claim 3 wherein the streamed-media file comprises a Java Applet™ file.

7. A method according to claim 1 wherein the step of compressing said at least partly compressible file comprises the steps of:
applying at least one predetermined type of compression algorithm to a data chunk of a predetermined size in said at least partly compressible file;
if the compression ratio obtained from applying said at least one type of algorithm exceeds a predetermined threshold, writing the compressed data chunk to a memory;
else, writing the data chunk uncompressed to said memory; and
repeating the above steps for a plurality data chunks in said at least partly compressible file.

8. A method according to claim 7 wherein the step of applying at least one type of compression algorithm to the at least partly compressible file comprises the steps of:
applying a first compression algorithm or combination of compression algorithms to said data chunk;
applying a second compression algorithm or combination of compression algorithms to said data chunk;
determining which of said first and second algorithms or combinations of algorithms yields a higher compression ration for said chunk;
using the higher compression ratio algorithm or combination of algorithms to compress said chunk.

9. A method according to claim 8 wherein at least one of said first and second compression algorithms or combinations of compression algorithms comprises a dictionary table type compression algorithm.

10. A method according to claim 8 wherein at least one of said first and second compression algorithms or combinations of compression algorithms comprises a Huffman tree type compression algorithm.

11. A method according to claim 1 wherein the step of decompressing said compressed file comprises the steps of:
collecting a chunk of data of said compressed file, said chunk having a predetermined size;
determining whether said data chunk has been compressed relative to the at least partly compressible file;
if the said data chunk is determined not to have been compressed, writing said data chunk to a memory;
else, decompressing said data chunk to produce a corresponding decompressed data chunk and writing the decompressed data chunk to said memory; and
repeating the above steps for a plurality data chunks of said compressed file.

12. A method according to claim 11, wherein the step of decompressing said data chunk comprises the step of applying at least one type of decompression algorithm to the compressed data chunk.

13. A method according to claim 12 wherein the step of applying at least one type of decompression algorithm to the at least partly compressible file comprises the steps of:
determining at least one type of compression algorithm that has been used to compress said data chunk; and
selecting said at least one decompression algorithm to match said at least one compression algorithm.

14. A method for preparing an at least partly compressible file for accelerated transfer from a server computer to a user computer, the server computer and user computer being connected via a communication network, the method comprising the steps of:
at least partly compressing the at least partly compressible file to produce a corresponding compressed file; and
storing the compressed file on the server computer.

15. A method according to claim 14 wherein the at least partly compressible file comprises a streamed-media file.

16. A method according to claim 15 wherein the streamed-media file comprises a Macromedia Flash™ file.

17. A method according to claim 15 wherein the streamed-media file comprises a Macromedia Shockwave™ file.

18. A method according to claim 15 wherein the streamed-media file comprises a Java Applet™ file.

19. A method according to claim 14 wherein the step of compressing said at least partly compressible file comprises the steps of:
applying at least one predetermined type of compression algorithm to a data chunk of a predetermined size in said at least partly compressible file;
if the compression ratio obtained from applying said at least one type of algorithm exceeds a predetermined threshold, writing the compressed data chunk to a memory;
else, writing the data chunk uncompressed to said memory; and
repeating the above steps for a plurality data chunks in said at least partly compressible file.

20. A method according to claim 19 wherein the step of applying at least one type of compression algorithm to the at least partly compressible file comprises the steps of:
applying a first compression algorithm or combination of compression algorithms to said data chunk;
applying a second compression algorithm or combination of compression algorithms to said data chunk;
determining which of said first and second algorithms or combinations of algorithms yields a higher compression ration for said chunk;
using the higher compression ratio algorithm or combination of algorithms to compress said chunk.

21. A method according to claim 20 wherein at least one of said first and second compression algorithms or combinations of compression algorithms comprises a dictionary table type compression algorithm.

22. A method according to claim 20 wherein at least one of said first and second compression algorithms or combinations of compression algorithms comprises a Huffman tree type compression algorithm.

23. A method of downloading a compressed file corresponding to a compressible file in a given format from a server computer to a user computer, the server computer and user computer being connected via a communication network, the method comprising the steps of:
receiving a request for the at least partly compressible file;
replacing the request for the at least partly compressible file with a request for the corresponding compressed file;
transferring the compressed file to the user computer; and
decompressing the compressed file at the user computer to reconstruct the at least partly compressible file.

24. A method according to claim 23 and further comprising, after the step of decompressing, the step of converting the reconstructed file into a form presentable to the user.

25. A method according to claim 23 wherein the at least partly compressible file comprises a streamed-media file.

26. A method according to claim 25 wherein the streamed-media file comprises a Macromedia Flash™ file.

27. A method according to claim 25 wherein the streamed-media file comprises a Macromedia Shockwave™ file.

28. A method according to claim 25 wherein the streamed-media file comprises a Java Applet™ file.

29. A method according to claim 23 wherein the step of decompressing said compressd file comprises the steps of:
collecting a chunk of data of said compressed file, said chunk having a predetermined size;
determining whether said data chunk has been compressed relative to the at least partly compressible file;
if the said data chunk is determined not to have been compressed, writing said data chunk to a memory;
else, decompressing said data chunk to produce a corresponding decompressed data chunk and writing the decompressed data chunk to said memory; and
repeating the above steps for a plurality data chunks of said compressed file.

30. A method according to claim 29, wherein the step of decompressing said data chunk comprises the step of applying at least one type of decompression algorithm to the compressed data chunk

31. A method according to claim 30 wherein the step of applying at least one type of decompression algorithm to the at least partly compressible file comprises the steps of:
determining a type of compression algorithm or combination of compression algorithms that have been used to compress said data chunk; and
selecting said at least one decompression algorithm to match said compression algorithm or combination of compression algorithms.

32. A system for transferring an at least partly compressible file from a server computer to a user computer, the server computer and user computer being connected via a communication network, the system comprising:
a compress program which at least partly compresses the at least partly compressible file to produce a corresponding compressed file;
a memory associated with the server computer for storing said compressed file;
means associated with the user computer for receiving a request for said compressible file and transmitting a request for said corresponding compressed file from the server computer via said communication link; and
a decompress program, associated with the user computer, which decompresses the compressed file to reconstruct the at least partly compressible file.

33. A system according to claim 32 and further comprising means for converting the reconstructed compressible file into a form presentable to the user.

34. A system according to claim 33 wherein the at least partly compressible file comprises a streamed-media file.

35. A system according to claim 33 wherein the streamed-media file comprises a Macromedia Flash™ file.

36. A system according to claim 33 wherein the streamed-media file comprises a Macromedia Shockwave™ file.

37. A system according to claim 33 wherein the streamed-media file comprises a Java Applet™ file.

38. A system according to claim 32 wherein said compress program comprises:
means for applying at least one predetermined type of compression algorithm to each of a plurality of data chunks of a predetermined size in said at least partly compressible file to produce corresponding compressed data chunk;
means for writing the compressed data chunk to said memory of the server computer if the compression ratio obtained from applying said at least one type of algorithm exceeds a predetermined threshold; and
means for writing the data chunk uncompressed to said memory of the server computer if the compression ratio obtained from applying said at least one type of algorithm does not exceed said predetermined threshold.

39. A system according to claim 38 wherein said means of applying at least one type of compression algorithm to each of the a plurality of chunks of at least partly compressible file comprises:
means for applying a first compression algorithm or combination of compression algorithms to said data chunk;
means for applying a second compression algorithm or combination of compression algorithms to said data chunk; and
means for determining which of said first and second algorithms or combinations of algorithms yields a higher compression ration for said chunk,
wherein the higher compression ratio algorithm or combination of algorithms is used to compress said data chunk.

40. A system according to claim 39 wherein at least one of said first and second compression algorithms or combinations of compression algorithms comprises a dictionary table type compression algorithm.

41. A system according to claim 39 wherein at least one of said first and second compression algorithms or combinations of compression algorithms comprises a Huffman tree type compression algorithm.

42. A system according to claim 32 wherein said decompress program comprises:
means for collecting a plurality of data chunks of said compressed file, said data chunks having a predetermined size;
means for determining whether each of said data chunks has been compressed relative to the at least partly compressible file;
means for writing each data chuck which is determined not to have been compressed to a memory of the user station;
means for decompressing exch data chunk which is determined to have been compressed to produce a corresponding decompressed data chunk and writing each decompressed data chunks to said memory.

43. A method according to claim 42, wherein said decompress program comprises means for applying at least one type of decompression algorithm to the compressed data chunk.

44. A method according to claim 43 wherein said means for applying at least one type of decompression algorithm to the at least partly compressible file comprises:
mens for determining at least one type of compression algorithm that has been used to compress said data chunk; and
means for selecting said at least one decompression algorithm to match said at least one compression algorithm.
